(19) United States
(12) Patent Application Publication
(10) Pub. No.: US 2026/0368307 A1
(43) Pub. Date: Nov. 19, 2026

(54) SYSTEM FOR ANTI-TAMPERING PREVENTION USING HYPERVISOR BASED SECURITY

(71) Applicant: Acronis International GmbH, Schaffhausen (CH)

(72) Inventors: Vladimir Strogov, Singapore (SG); Aliaksei Dodz, Singapore (SG); Serg Bell, Singapore (SG); Stanislav Protasov, Singapore (SG)

(21) Appl. No.: 19/208,737

(22) Filed: May 15, 2025

(51) Int. Cl. G06F 21/53

(52) U.S. Cl. CPC G06F 21/53; G06F 2221/034

(57) ABSTRACT

Systems and methods employ Virtualization-Based Security (VBS) for protecting computer system resources. Systems and methods enforce a VBS-protected execution pipeline, ensuring that security-sensitive operations are validated before execution at both user and kernel levels. A security model uses VBS to enforce kernel-mode protections and prevent privilege escalation attacks. Systems and methods can utilize self-protection and user-mode enforcement against user-mode threats.

### TECHNICAL FIELD

The present disclosure generally relates to anti-malware solutions for computer systems. More particularly, the disclosure relates to protecting critical processes and system operations from kernel-level attacks, such as rootkits and unauthorized modifications, by leveraging Virtualization-Based Security (VBS) to control execution, validate operations, and prevent tampering with security-critical components.

### BACKGROUND

Modern operating systems are increasingly targeted by advanced kernel-mode attacks, including rootkits and privilege escalation exploits, which allow attackers to gain unauthorized kernel access. Other attacks tamper with security processes, effectively disabling endpoint protection and evading detection. Yet other attacks compromise system drivers, enabling malware to bypass security mechanisms and modify critical system operations.

Existing security solutions often fail due to reliance on user-mode security software, which is ineffective against low-level system compromises. Vulnerabilities also exist in traditional self-protection mechanisms (self-defense, anti-tampering), which can be bypassed by sophisticated kernel attacks. Weak enforcement of kernel security policies may allow malicious actors to modify sensitive files, registries, and security processes.

Traditional self-protection (anti-tampering) mechanisms rely on process privileges but do not protect against kernel-level threats. Such solutions can be disabled by attackers with privileged access. Endpoint Detection and Response (EDR) solutions focus on monitoring and threat detection, rather than preventing modifications at the kernel level. Also, EDR solutions do not provide real-time execution control to block malicious actions. Secure boot and code integrity protections prevent unauthorized drivers from loading, but do not prevent runtime modifications. Malicious actors can bypass these measures by injecting malicious kernel modules or modifying trusted drivers. Thus, there is a need for improved systems and methods that protect security processes from being tampered with, especially by malicious actors who are able to gain kernel access.

There is a further need for a security architecture that optimizes available tools, including virtualization-based isolation, to allow sensitive operations to be evaluated and authorized in a secure user-mode environment, even if kernel components are compromised.

### SUMMARY

An improved security model uses Virtualization-Based Security (VBS) to enforce strict kernel-mode protections and prevent privilege escalation attacks. Embodiments can utilize self-protection and user-mode enforcement against user-mode threats.

In an embodiment, system resources or objects are protected using a virtually isolated security process that monitors operations of a computer system with a virtually isolated kernel driver. The monitored operations comprise file access, registry modifications, process manipulations, and process terminations. Operations monitored by the virtually isolated kernel driver are intercepted and forwarded to a dedicated security process. Execution authorization of the intercepted operation is determined by the dedicated security process by comparing the intercepted operation information to security rules and generating a security decision to allow or block the operation. A security decision of the intercepted operation is transmitted by the dedicated security process to the virtually isolated kernel driver. The intercepted operation is executed by the virtually isolated kernel driver if the security decision’s decision is to allow execution and prevented if the decision is to block execution.

In various embodiments, comparing the intercepted operation information to security rules includes validating by masking or by object access requests for write operations on protected files. In some embodiments, preventing unauthorized execution further comprises tracking a security configuration change and rejecting an unauthorized modification to a system object. Other embodiments include protecting the dedicated security process with Process Protection Light (PPL), isolating the security rules by way of an enclave, protecting the virtually isolated kernel driver with VBS, and providing secure communication between kernel and user mode through a dedicated Application Program Interface (API) interface. In a further embodiment, generating a security decision includes a security decision to modify the operation.

In an embodiment, a system for protecting system resources or objects using a virtually isolated security process includes a processor coupled to a memory and nonvolatile storage and a hypervisor, under processor control. The system further includes an operating system, running on the hypervisor, configured with a virtually isolated kernel mode and a virtually isolated user mode. Further system features include a kernel filter driver, running in the virtually isolated kernel mode, configured to intercept requests from user mode applications to perform an operation. A dedicated security process, running in the virtually isolated user mode, is configured to determine whether the operation is authorized. A plurality of security rules, stored in the virtually isolated user mode, are provided for regulating access by operations to system objects. The kernel filter driver is configured to intercept predetermined operations and pass them to a dedicated security process. The dedicated security process is configured to check predetermined operations against the plurality of security rules and transmit an authorization decision to the kernel filter driver. The kernel filter driver is further configured to allow execution or block execution of operations in accordance with the authorization decision of the dedicated security process.

In one aspect, checking predetermined operations against the plurality of security rules includes validating by masking or by object access requests for write operations on protected files. Blocking execution of operations can include tracking a security configuration change and rejecting unauthorized modifications to a predetermined system object or resource. The dedicated security process can be protected by Protected Process Light (PPL) and the plurality of security rules can be isolated by way of an enclave. In some embodiments, the virtually isolated kernel driver is protected by Virtualization Based Security (VBS). The authorization decision can include a security decision to modify the operation.

In one aspect, system resources or objects are protected using a virtually isolated security process as described above with the addition of a dedicated execution API. The dedicated execution API, configured as part of a trusted communication channel between the kernel component and user-mode security process, receives the security decision for the intercepted operation sent by the dedicated security process. The operation intercepted by the virtually isolated kernel driver is allowed to execute if the security decision is to allow and the security decision is passed through the dedicated execution API.

### BRIEF DESCRIPTION OF THE DRAWINGS

Implementations of the invention are explained in the following detailed description of various embodiments with reference to the accompanying figures, in which:

FIG. 1 is a block diagram in accordance with an embodiment.

FIG. 2 is a block diagram in accordance with an embodiment.

FIG. 3 is a flow diagram in accordance with an embodiment.

FIG. 4 is an alternative flow diagram in accordance with an embodiment.

The embodiments described are exemplary ways to use the invention to solve technical problems in the field of the invention. The solutions and techniques disclosed may also be used to solve other problems in the field or to solve similar problems in other fields. Substitutions, modifications, and equivalents known to those of skill in the art may be used to implement these solutions and techniques, consistent with scope of the invention described in the claims.

### DETAILED DESCRIPTION

Systems and methods are disclosed that employ Virtualization-Based Security (VBS) for protecting computer system resources. The systems and methods enforce a VBS-protected execution pipeline, ensuring that security-sensitive operations are validated before execution at both user and kernel levels. At the same time, a dedicated security application used for filtering user mode requests is itself protected from tampering by malicious actors.

Virtualization-Based Security (VBS), generally speaking, is a security feature that uses a hypervisor to create an isolated, virtual environment on a computer system. Within this environment, applications can be protected from malicious actors. A VBS-Protected kernel driver prevents modification or unloading, even by privileged attackers. A restricted kernel modification path validates all kernel changes in a controlled VBS enclave. This validation helps to block rootkit tampering, preventing privilege escalation, and counters attack vectors that rely on modifying security components.

In embodiments, kernel-mode drivers receive user requests for file input/output (I/O) from user mode. These user requests are processed by kernel mode filter drivers. Processing involves intercepting, evaluating, and optionally modifying or rejecting the I/O requests based on defined filtering logic. In some embodiments, a novel operation is included whereby certain high-risk or sensitive I/O requests—identified based on predefined rules or heuristics—are conditionally escalated from the kernel-mode filter driver to a VBS-protected user-mode enclave for authorization before execution. For example, in one configuration, a filter manager (e.g. FltMgr.sys) acts as a kernel-mode driver that implements and exposes file system filter drivers. FltMgr works with minifilter drivers, which are attached to a file system stack indirectly and registered with FltMgr for filtering certain I/O operations.

A VBS enclave (enclave) refers to an isolated region of memory within the address space of a user-mode process. In one aspect, the enclave is a software-based trusted execution environment inside a host application’s address space. VBS enclaves use virtualization to isolate part of the host application in a secure memory partition. This region of memory is controlled entirely by a hypervisor (e.g. Windows Hyper-V). The hypervisor creates a logical separation between ordinary user mode and kernel mode and secure (isolated) modes.

A typical enclave comprises a shared library (dynamic link library (DLL) in Windows or a shared (.so) object or library in GNU/Linux) and has a corresponding host application. In various embodiments described below, the host application is a dedicated security process and the enclave provides a secure region within the dedicated security process.

In embodiments where a DLL is used, the DLL comprises a module that contains functions and data that can be used by another module (application or DLL). In the context of DLLs, a module refers to a portable executable file, such as example.dll or program.exe, with at least one class and interface. The DLL can define exported functions, which are intended to be called by other modules, as well as from within the DLL where they are defined.

An exemplary workflow starts when an I/O request is made from user mode to modify a system resource. Such requests generally comprise file system operations, such as create, read, write, and so on. For example, a hypothetical request concerns writing to a critical file, such as config.sys. Because the request concerns a critical file, the request is intercepted by a kernel filter driver, such as a dedicated minifilter driver (minifilter), that is configured to protect the critical file (e.g. config.sys). In an embodiment, a request that does not modify system files or attempt superuser (e.g., administrator) actions, such as a request from a web browser, is not intercepted by the dedicated kernel driver (e.g. minifilter) because it is excluded by a rules verifier module that filters operations based on predefined criteria. The rules verifier determines whether a request matches the conditions for interception and escalation.

In an embodiment, a minifilter architecture is used to process I/O requests. In such embodiments, a filter manager and one or more loaded minifilters are used for I/O processing. In response to a supported operation, the filter manager calls a correlated preoperation callback function in a loaded minifilter. The minifilter completes its preoperation routine and returns control to the filter manager. When minifilter processing is completed, a file system driver processes the operation. The filter manager invokes postoperative callback functions in reverse order. When minifilter processing is complete, control is returned to the I/O manager and then back to the original application making the I/O request.

An exemplary application of a kernel filter driver, such as a minifilter, includes detection of suspicious system events, such as a memory dump. A minifilter that processes the relevant I/O operation (e.g. IRP_MJ_CREATE, IRP_MJ_WRITE or IRP_MJ_SET_INFORMATION) can intercept attempts to access or modify protected file paths (e.g., application configuration files, installation directories) or registry keys. These operations can correspond to file creation, writing, renaming, or deletion.

In some embodiments, Protected Process Light (PPL) is used to secure security system processes. PPL refers to a mechanism that allows signed applications to run in a tamper-safe mode, protected even from processes with superuser privileges. Structurally, the PPL mechanism includes three key elements: (1) a digital signature validated against a policy-defined certificate chain, (2) an access token associated with the process that encodes its protection level, and (3) kernel-mode enforcement logic that restricts inter-process interactions based on protection level hierarchy. The signing levels of PPLs can be adjusted to create hierarchical levels of access among protected processes. These include levels such as “WinTcb” (highest), ”Windows,” “Lsa,” “Antimalware,” and “App.” Processes at a higher PPL level cannot be modified or debugged by those at a lower level. For example, a dedicated security process can be secured with PPL to provide more security from tampering by malicious actors. In an embodiment, the dedicated security process is signed with a certificate chain that grants it an "Antimalware" or higher PPL level, ensuring it remains inaccessible to standard user-mode applications or even other security agents operating at a lower level.

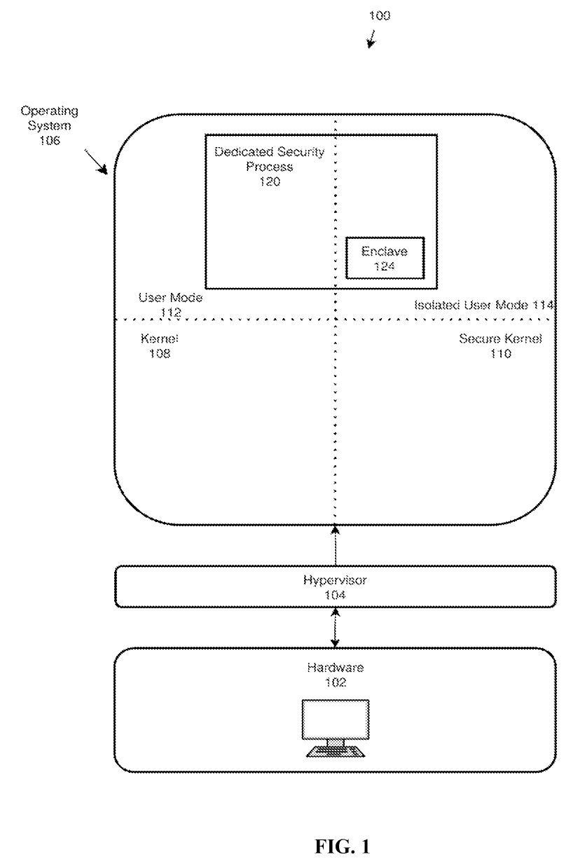

FIG. 1 is a block diagram showing an exemplary configuration of a virtualization-based system 100 where hardware 102, such as a personal computer or server, is running hypervisor 104. Hardware 102 includes, for example, one or more suitable processors (e.g. 64-bit processor with second-level address translation (SLAT) for Windows Hyper-V), memory (usually at least 16GB RAM), and nonvolatile storage. Operating system 106 (e.g. Microsoft Windows, GNU/Linux, etc.) is installed on top of hypervisor 104. Operating system 106 comprises a kernel space with kernel 108 and secure kernel space 110. Also part of operating system 106 is a user space with user mode 112 and isolated user mode 114.

In one aspect, isolated user mode 114 refers to a virtualized, hardware-enforced execution environment created by the hypervisor 104, including using features such as Microsoft’s Virtual Secure Mode (VSM) or Isolated User Mode (IUM). This environment is distinct from standard user mode 112 and is protected from access by most other user-mode processes and kernel-mode drivers.

Code running in isolated user mode 114 is often executed within a Virtual Trust Level (VTL) 1 context, whereas standard kernel and user mode components operate at VTL 0. This separation guarantees that even if the kernel (108) or user space (112) is compromised, the sensitive logic or data stored in isolated user mode—such as enclave 124—remains protected from tampering or inspection.

In the context of this disclosure, isolated user mode 114 hosts security-critical components of the dedicated security process 120, such as a trusted-code-signed enclave, responsible for storing and applying security rules or verifying sensitive operations. This configuration improves resilience against privilege escalation and advanced persistent threats (APTs).

Within user mode 112 is dedicated security process 120, part of which (including enclave 124) resides in isolated user mode 114. Dedicated security process 120 can be protected further by, for example, by signing with PPL.

In operation, system 100 provides real-time protection against unauthorized modifications to security-critical components by routing sensitive operations through a hardened evaluation pipeline. When an application or driver initiates a security-relevant action (e.g., modifying a protected file, terminating a monitored process), the operation is intercepted by a VBS-protected kernel component (not shown in FIGS. 1, see 2). If the operation targets a protected object, metadata is forwarded to dedicated security process 120, which resides in user mode 112 but includes security-critical logic—such as enclave 124—running in isolated user mode 114.

Within isolated user mode 114, enclave 124 compares the information of the intercepted operation against stored security rules, which may include object masks, access types, and action directives (e.g., allow, deny, escalate). If the operation is permitted, execution authorization is returned to the kernel driver, optionally followed by secure execution of the operation on behalf of the original requester. If the operation is denied, the request is blocked before reaching the system object. The hypervisor 104 enforces isolation between execution contexts, ensuring that enclave 124 and associated rule evaluation logic remain inaccessible to potentially compromised components in kernel 108 or user mode 112. This layered architecture allows system 100 to maintain strong anti-tampering guarantees across user and kernel modes.

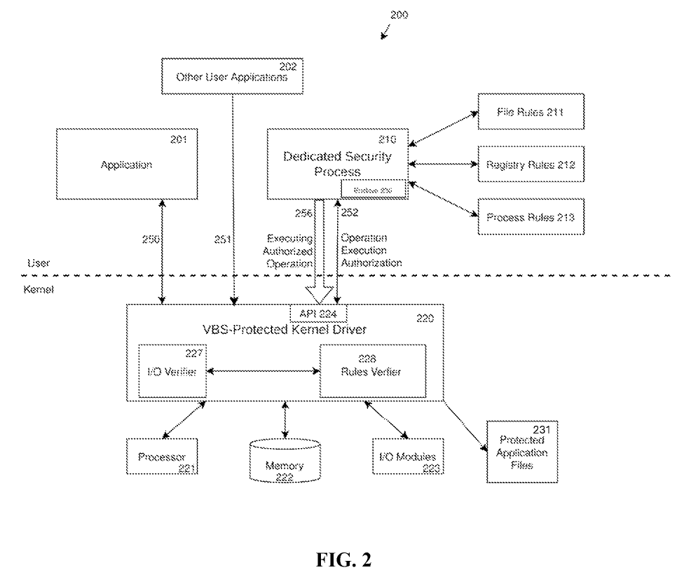

FIG. 2 shows a block diagram of an embodiment of a VBS-protected system security architecture 200. In FIG. 2, the VBS-protected kernel security architecture is configured to enforce access control and prevent unauthorized modifications to system processes, files, and registry entries. In one aspect, execution paths are restricted and security-sensitive operations are validated before execution at both user and kernel levels. In one aspect, restrictions can include blocking direct kernel-mode access to protected memory ranges, denying write access to specified registry keys, and rejecting process creation or termination attempts that violate predefined rules. Validation can include checking intercepted operations against a rules database located in an enclave and verifying the origin and integrity of the request (e.g., whether the calling process is signed or PPL-protected). In this embodiment, execution paths are restricted and security-sensitive operations are validated before execution at both user and kernel levels. The restriction and validation may occur serially, where kernel-level interception precedes user-mode rule validation via the dedicated security process. Alternatively, in optimized configurations, certain classes of rules (e.g., known file path masks) may be prevalidated at the kernel level, while more complex decisions are deferred to enclave-backed user-mode evaluation in parallel with ongoing system operations.

The components of architecture 200 include an exemplary application 201, which represents a potentially malicious software application operating in user mode on system 200. A malicious application can attempt to execute unauthorized operations such as file modifications, process termination, or registry changes. Also shown in FIG. 2 are other exemplary user applications 202, which represent applications running on system 200 generally, including both trusted and potentially malicious applications. Both applications 201 and 202 make I/O requests (250, 251 respectively) for various operations to the VBS-protected kernel driver 220.

A dedicated security process 210 contains VBS-protected enclave 230. Dedicated security process 210 is a trusted, isolated process responsible for evaluating security-sensitive operations before their execution by the operating system. In an embodiment, the dedicated security process 210 uses a VBS-protected enclave to prevent unauthorized modifications. Dedicated security process 210 is in communication with a security rules database, which is represented by exemplary rules 211-213. Rules 213, which will be described in detail below, can be used by dedicated security process 210 as references in determining whether an operation is authorized or should be blocked. In an embodiment, rules 211-213 are stored generally within isolated user mode 114 of FIG. 1 or specifically within enclave 230 of FIG. 2.

In one aspect, architecture 200 further comprises VBS-protected kernel driver 220. VBS-protected kernel driver 220 is configured to intercept, verify, and control system operations at the kernel level. VBS-protected kernel driver 220 interacts with the dedicated security process 210 by way of Application Program Interface (API) 224 to determine whether execution of a particular operation will be authorized. Execution proceeds or is blocked based on the security decision received from the dedicated user-mode process. Accordingly, VBS-protected kernel driver can comprise a combination of hardware and software, such as by a microprocessor 221 and a set of program instructions that adapt VBS-protected kernel driver 220 to implement its particular functionality, which (while being executed) transform the microprocessor 221 into a special-purpose device. VBS-protected kernel driver 220 can also be implemented as a combination of the two, with certain functions facilitated by hardware alone, and other functions facilitated by a combination of hardware and software.

Architecture 200 employs a security rules database to define access restrictions and security enforcement policies that will be enforced to regulate system modifications. In an embodiment, the security rules database is divided into rule sets. One exemplary rule set comprises file rules 211, which restrict unauthorized file modifications. Another set of exemplary rules are registry rules 212, which prevent malicious registry alterations. A third set of exemplary rules are process rules 213, which enforce security constraints on process execution and termination. In an embodiment, the rules 211-213 have the form of a table listing objects, access type, and corresponding verdicts (e.g. allow, block, modify).

Kernel-level security enforcement mechanisms are also provided. I/O verifier 227 monitors and validates I/O operations to prevent unauthorized access to system resources. I/O Verifier 227 categorizes I/O operations into three types: file system operations (e.g., file create, write, rename, delete), registry modifications (e.g., key creation, value setting), and process-level actions (e.g., process open, suspend, terminate). For file and registry operations, enforcement rules can specify target object paths using masks or explicit path definitions (e.g., \ProgramData\Acronis\*, \Users\*\Documents\*.docx, or specific registry hives such as HKLM\Software\Vendor\Security).

More particularly, in one aspect, validating an intercepted operation by mask refers to checking whether the object associated with the operation matches a predefined access control pattern specified in the security rules. A mask may include wildcarded path expressions, registry key patterns, or access flag patterns that describe a class of protected resources. For example, a file rule mask might be \Windows\System32\.sys to denote all driver files, or \Users\\Documents\*.docx to target user documents. The intercepted object path (or registry path or process handle) is compared to such masks using pattern matching logic (e.g., wildcard matching or prefix/suffix comparison). If a match is found, the rule is triggered, and further validation proceeds—either directly in the kernel or escalated to the Dedicated Security Process.

Mask-based validation is especially useful for detecting attempts to access dynamically named or user-specific resources. In some cases, access masks are also used to match the type of access being requested (e.g., GENERIC_WRITE, DELETE, PROCESS_TERMINATE) using bitwise evaluation. The operation is allowed, blocked, or modified based on these comparisons and the rule’s defined reaction.

Process protection is implemented by intercepting requests to open processes with specific access rights that may pose a risk to security-critical components. These access rights are evaluated against predefined protection rules and access masks. Typical access rights subject to enforcement include:
PROCESS_VM_WRITE – allows writing to the memory of another process
PROCESS_TERMINATE – enables termination of a process
PROCESS_SUSPEND_RESUME – permits suspension or resumption of process threads
PROCESS_CREATE_THREAD – allows creating new threads in a remote process.
If an intercepted operation includes any of these rights for a protected process, the request is subject to validation by the dedicated security process before execution is allowed.

Rules verifier 228 performs a prefiltering function, evaluating whether an intercepted operation corresponds to a rule requiring additional hardening. In this context, “hardening” refers to improved security treatment applied to sensitive operations that pose elevated risk—such as those targeting protected system files, registry keys, or critical processes. Hardening includes enforcing stricter rule validation, escalating the operation to a trusted execution path, or executing the operation under supervision of a protected user-mode component. In this role, Rules verifier 228 determines whether a rule applies to the intercepted operation and whether the intercepted operation should be escalated to user-mode enforcement. Rules verifier 228 can also apply a flag to indicate whether an intercepted operation must undergo strict hardening through invocation of API 224. This flag determines whether execution must be explicitly authorized by a trusted enclave-backed verdict, even if an initial kernel-level rule exists. System resources protected by architecture 200 include memory 222, a secure memory space preventing unauthorized modifications. I/O modules 223 are hardened interfaces designed to prevent tampering via peripheral channels and I/O pathways. Structurally, I/O modules 223 can include kernel-level hooks, filter drivers, or hypervisor-enforced guards that monitor low-level data movement—especially attempts to inject payloads or modify protected system areas through nontraditional vectors such as virtual devices, memory-mapped I/O, or USB emulation. I/O modules 22 can include logic to detect signature anomalies, rate-limit suspicious access attempts, and reject write operations targeting monitored resources unless explicitly approved by the dedicated security process. Protected application files 231 comprise a defined set of executables, configuration files, and runtime dependencies marked as tamper-protected. Each file may be cryptographically hashed at load time, with the hash verified against enclave-stored reference values. Any deviation triggers enforcement logic—blocking execution, reverting to a trusted version, or escalating the event to the user-mode security process. The protection also includes defense against timestamp manipulation, alternate data stream injection, and unauthorized DLL replacement because these techniques can be indications of malicious operations.

In an exemplary embodiment, a workflow using architecture 200 includes interception of security-sensitive operations by VBS-protected kernel driver 220. Security-sensitive operations include, for example, file modifications, registry changes, and process injections.

The workflow then validates the intercepted operations by sending information about these intercepted operations to the dedicated security process 210 for evaluation based on security rules 211-213. An operation execution authorization 252 is communicated to VBS-protected kernel driver 220. If the execution of the operation is approved by the dedicated security process 210, the operation is executed through the controlled VBS environment, as represented by 256 in FIG. 2. If execution of the operation is denied by the dedicated security process 210, the operation is blocked at the kernel level by the VBS-protected kernel driver 220 to prevent security breaches. For example, if the intercepted operation involves writing to a protected file or terminating a security-critical process, the VBS-protected kernel driver 220 may respond by returning an STATUS_ACCESS_DENIED error code to the caller, nullifying the IRP (I/O Request Packet), and logging the attempt for audit. In some embodiments, the VBS-protected kernel driver 220 can also terminate or suspend the calling process if the attempted action is classified as hostile based on rule metadata.

In exemplary embodiments, self-protection mechanisms are strengthened by leveraging Virtualization-Based Security (VBS) across system components, such as a trusted enclave that confers protection for user mode and a VBS-protected kernel driver that confers kernel mode protection. The trusted enclave and VBS-protected kernel driver work together as part of a security enforcement layer, where decision-making and security operations take place in a secure environment.

For example, in an embodiment, all intercepted operations, typically in the form of requests, originating in user mode are first captured by the VBS-protected kernel driver. An intercepted request is then verified within the dedicated security process, for example, inside the trusted enclave. If the operation is authorized, execution proceeds by the VBS-protected kernel driver. The VBS-protected kernel driver, recognizing that the request originates from a trusted security process, then executes the operation securely.

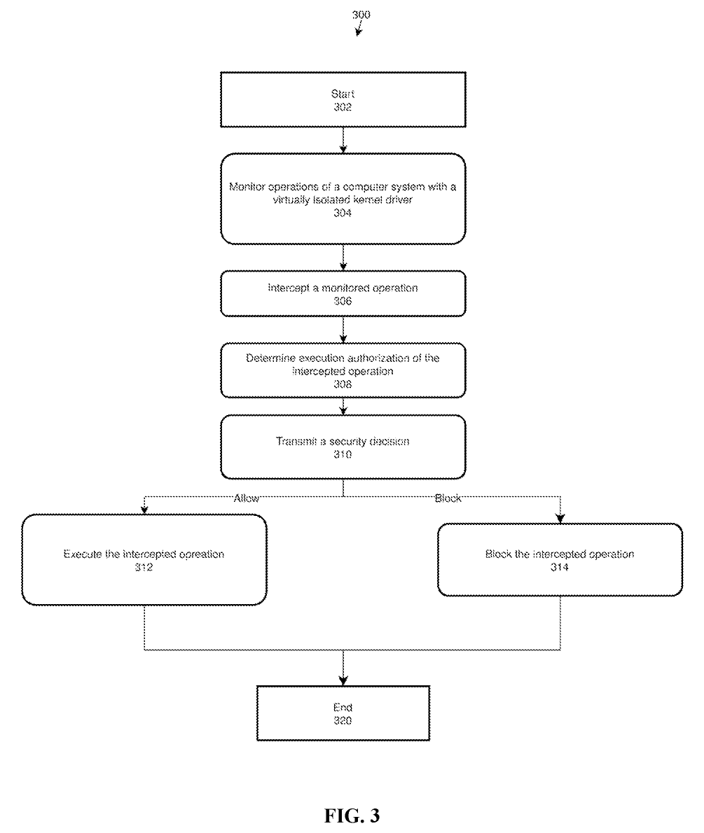

FIG. 3 is a flow diagram showing an exemplary workflow 300 employing the architecture of either FIGS. 1 or 2 or a combination of both. At 302, a kernel filter driver (such as a minifilter) is loaded and prepared for processing I/O requests for certain, predefined security-sensitive file system operations, such as modifying system files, deleting or overwriting files with sensitive data, registry changes, and other operations associated with malware. As I/O requests are made from user mode, operations are monitored at 304. An operation meeting the predefined requirements is intercepted by the kernel filter driver at 306. The authorization of the intercepted operation is checked at 308, for example, by passing the intercepted operation to a dedicated security process protected by a VBS enclave. In an embodiment, the system first checks whether a cached authorization verdict exists for the intercepted operation. The cache can store recent verdicts received from the dedicated security process, keyed by operation information and object identifier, and can include a time-to-live (TTL) parameter to limit reuse of stale decisions. If a valid cached verdict exists, it is used directly. Otherwise, the operation is forwarded to the dedicated security process. The dedicated security process determines the authorization status of the intercepted operation with reference to file, registry, or process rules also stored with isolated user mode or within a VBS-protected enclave. A security decision (allow or block) is made by the dedicated security process and transmitted to a VBS-protected kernel driver at 310.

The VBS-protected kernel driver verifies that an operation authorized by an enclave and dedicated security process indicates that the operation should be allowed. If these conditions are met, execution is allowed at 312. If these conditions are not met, execution is blocked at 314. Once execution has been either allowed or blocked by the VBS-protected kernel driver, the process ends at 320 and is ready to be repeated. For file system and registry operations, this process applies the same verification and enforcement techniques. If the requested object is not protected (e.g., by a loaded minifilter), the operation is simply allowed to proceed without intervention by the dedicated security process.

For improved system performance, unprotected objects can be excluded from passing through the VBS-protected kernel driver. For example, processing can be limited to explicitly protected objects, thereby reducing the system resources needed for processing objects.

Objects can be processed in a variety of ways consistent with increased security. For example, if an object is protected, the kernel driver intercepts access attempts. If the access request originates outside the protected, dedicated security process or outside the enclave, the security process is queried to determine whether the operation is allowed. If the security process denies the operation, execution is blocked at the kernel level. If allowed, execution may proceed directly within the security process context, or by invoking a dedicated API within the VBS-protected kernel driver, ensuring that the operation is executed only by way of a controlled security path.

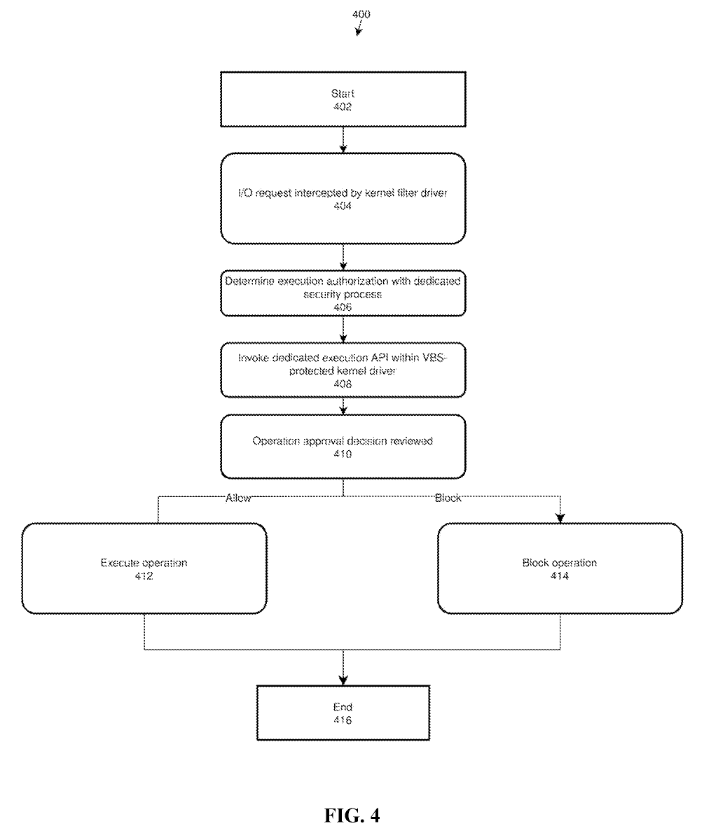

A flow diagram of an alternative exemplary workflow 400 is shown in FIG. 4. A dedicated execution API, exemplified by API 224 in FIG. 2, provides an additional verification step. The dedicated API for secure execution acts as a replacement for directly modifying protected resources. Operations that implicate protected resources can be explicitly requested through a specialized API call from the enclave to the VBS-protected kernel driver. The use of this API call serves as a trusted execution gateway, ensuring all security-sensitive actions undergo verification. If an operation is approved, the VBS-protected kernel driver executes it securely. If not, the request is rejected before it reaches the kernel. This two-step execution process prevents unauthorized modifications and adds an extra layer of security against kernel-level threats.

At 402, a kernel filter driver (e.g. a minifiler) is loaded and prepared for processing, along with a dedication execution API. An I/O request is intercepted at 404 by the kernel filter driver and passed to the dedicated security process. At 406, an execution authorization decision is made by the dedicated security process. The decision is then transmitted to the VBS-protected kernel driver by invoking the dedicated execution API at 408. At 410, the operation approval decision is reviewed and either allowed by executing the operation at 412 or blocked at 414. The process ends at 416 and is ready to be repeated for further I/O requests.

In embodiments, kernel-mode attacks are mitigated in a variety of ways. For example, user applications (such as application 201 in FIG. 2) never execute directly within the security process context. All intercepted operations pass through the VBS-protected kernel driver, which allows execution (if permitted by security rules), or rejects execution (if the process is untrusted). Thus, privilege-escalation attacks are prevented because a malicious actor cannot bypass security protections by injecting malicious operations into trusted system processes.

In exemplary embodiments, the dedicated security process handles predetermined security-critical decisions. For example, critical operations can be routed through the VBS-protected kernel driver, while less critical operations, such as read and write requests to user files, are allowed to execute within the security process context without additional overhead. In exemplary embodiments, security rule enforcement and execution control is implemented by way of granular execution policies. For example, instead of simply allowing or denying an operation, the system may specify how the operation should be executed or whether the operation execution request should pass through the enclave or VBS-protected kernel driver. Alternatively, if an application accesses a sensitive registry key, execution is routed through the VBS-protected kernel driver. When an application modifies a non-sensitive setting, however, execution can proceed without additional verification.

In an embodiment, the dedicated security process can operate in PPL mode and determines whether an operation should proceed. Execution requests are analyzed through security rules stored in a dedicated security enclave. If a request does not conform to preloaded rules, it is blocked at the kernel level.

Registry protection is ensured by subjecting registry operations to binary decision logic (allowed/denied). Security-critical registry values are restricted from modification unless authorized by the dedicated security process. File system protection is ensured by analyzing file modifications against preloaded security rules within the dedicated security process. Unauthorized attempts to modify protected files are automatically rejected by the VBS-Protected Kernel Driver.

Process termination control is implemented by intercepting kernel-level termination attempts and preventing unauthorized processes from terminating security-critical applications. The dedicated security process verifies termination requests. If the process is protected, termination is denied. If the request originates from a suspicious kernel module, it is intercepted and flagged for review.

In various embodiments, the roles of the main security components can be divided such that the VBS-protected kernel driver controls all execution paths for security-sensitive operations and protects the dedicated security process from unauthorized modifications. The dedicated security process, running in user mode, can also run in PPL mode to resist user-mode privilege escalation attacks. The dedicated security process can maintain a record of security rules to validate all modification attempts. The VBS-protected kernel driver compares incoming requests against preloaded security rules before execution. If an operation is unauthorized, the operation is rejected and logged for analysis. In an embodiment, modifications made to a system object by unauthorized operations that are not blocked can be remedied by tracking changes and reverting the system object to its state before the unauthorized operation was executed. For example, where an unauthorized operation targeting a system file is detected and logged, analysis can reveal that the system file has already been altered by an unblocked, unauthorized operation. In such cases, remedial action can include reverting the system file to its previous state.

1. A method for protecting a computer system using a virtually isolated security process, the method comprising:
monitoring operations of the computer system with a virtually isolated kernel driver, wherein the monitored operations comprise file access, registry modifications, process manipulations, or process terminations;
intercepting a monitored operation with the virtually isolated kernel driver;
forwarding intercepted operation information to a dedicated security process;
determining execution authorization of the intercepted operation, wherein execution authorization is determined by the dedicated security process by comparing the intercepted operation information to security rules and generating a security decision to allow or block the intercepted operation;
transmitting the security decision of the intercepted operation by the dedicated security process to the virtually isolated kernel driver;
when the security decision is to allow execution, executing the intercepted operation by the virtually isolated kernel driver; and
when the security decision is to block execution, preventing execution of the intercepted operation by the virtually isolated kernel driver.

2. The method of claim 1, wherein comparing the intercepted operation information to security rules includes validating by masking.

3. The method of claim 1, wherein preventing unauthorized execution further comprises tracking a security configuration change and rejecting an unauthorized modification to a system object.

4. The method of claim 1, wherein comparing the intercepted operation information to security rules includes validating by object access requests for write operations on protected files.

5. The method of claim 1, wherein the security rules are isolated by an enclave.

6. The method of claim 1, wherein the virtually isolated kernel driver is protected by Virtualization Based Security (VBS).

7. The method of claim 1, wherein generating the security decision further comprises a security decision to modify the operation.

8. A system comprising:
a processor coupled to a memory and nonvolatile storage;
a hypervisor, under processor control;
an operating system, running on the hypervisor, configured with a virtually isolated kernel mode and a virtually isolated user mode;
a kernel filter driver, running in the virtually isolated kernel mode, configured to intercept requests from user mode applications to perform an operation;
a dedicated security process, running in the virtually isolated user mode, configured to determine whether the operation is authorized;
a plurality of security rules, stored in the virtually isolated user mode, for regulating access by operations to system objects;
wherein the kernel filter driver is configured to intercept predetermined operations and pass the predetermined operations to the dedicated security process, wherein the dedicated security process is configured to check predetermined operations against the plurality of security rules and transmit an authorization decision to the kernel filter driver; and
wherein the kernel filter driver is further configured to allow execution or block execution of operations in accordance with the authorization decision of the dedicated security process.

9. The system of claim 8, wherein checking predetermined operations against the plurality of security rules further comprises validating by masking.

10. The system of claim 8, wherein blocking execution of operations comprises tracking a security configuration change and rejecting unauthorized modifications to a predetermined system object or resource.

11. The system of claim 8, wherein checking predetermined operations against the plurality of security rules further comprises validating by object access requests for write operations on protected files.

12. The system of claim 8, wherein the plurality of security rules are isolated by an enclave.

13. The system of claim 8, wherein the virtually isolated kernel driver is protected by Virtualization Based Security (VBS).

14. The system of claim 8, wherein the authorization decision further comprises a security decision to modify the operation.

15. A method for protecting a computer system using a virtually isolated security process, the method comprising:
monitoring operations of a computer system with a virtually isolated kernel driver, wherein the monitored operations comprise file access, registry modifications, process manipulations, or process terminations;
intercepting a monitored operation with the virtually isolated kernel driver;
forwarding the intercepted operation information to a dedicated security process;
determining execution authorization of the intercepted operation, wherein execution authorization is determined by the dedicated security process by comparing the intercepted operation information to security rules and generating a security decision to allow or block the operation;
transmitting the security decision of the intercepted operation by the dedicated security process to a dedicated execution Application Program Interface (API) within the virtually isolated kernel driver;
when the security decision is to allow and has been passed through the dedicated execution API, executing the intercepted operation by the virtually isolated kernel driver; and
when the security decision is to block, preventing execution of the intercepted operation by the virtually isolated kernel driver.

16. The method of claim 15, wherein comparing the intercepted operation information to the security rules includes validating by mask or by object access requests for write operations on protected files.

17. The method of claim 15, wherein preventing unauthorized execution further comprises tracking a security configuration change and rejecting an unauthorized modification to a system object or resource.

18. The method of claim 15, wherein the dedicated security process is protected by Process Protection Light (PPL).

19. The method of claim 15, wherein the security rules are isolated by an enclave.

20. The method of claim 15, wherein the virtually isolated kernel driver is protected by Virtualization Based Security (VBS).
